(19) United States
(12) Patent Application Publication
(10) Pub. No.: US 2004/0041859 A1
(43) Pub. Date: Mar. 4, 2004

(54) Ink level detecting device for inkjet printer

(75) Inventor: In-Su Hwang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon City (KR)

(21) Appl. No.: 10/652,489

(22) Filed: Sep. 2, 2003

(30) Foreign Application Priority Data
Sep. 2, 2002 (KR) 2002-52619

(51) Int. Cl. B41J 2/195

(52) U.S. Cl. 347/7

(57) ABSTRACT

An ink detecting device of an inkjet printer includes an ink tank, a supporting member, a luminous member, and a photo detector. The ink tank includes a predetermined amount of ink, and the supporting member is disposed at a predetermined position to detect when an ink level is decreased below a predetermined level. The luminous member includes a self-luminous material and is supported by the supporting member. The photo detector detects a light emitted from the luminous member when the ink level in the ink tank is lower than the predetermined level.

### CROSS-REFERENCE TO RELATED APPLICATIONS

This application claims the benefit of Korean Application No. 2002-52619, filed Sep. 2, 2002, in the Korean Intellectual Property Office, the disclosure of which is incorporated herein by reference.

### BACKGROUND OF THE INVENTION

1. Field of the Invention

The present invention relates to an ink level detecting device for an inkjet printer, and more particularly to an ink level detecting device for an inkjet printer to detect when ink is low by using a luminous member composed of self-luminous material.

2. Description of the Related Art

As an inkjet printer has been commercialized, many devices to detect an amount of ink in an ink tank of the printer are developed.

Among the, devices using optical sensors to sense a light through the ink tank are generally used to detect the amount of ink. However, the devices using the optical sensors have to adopt separate luminous devices, causing a manufacturing cost of the devices to rise.

### SUMMARY OF THE INVENTION

Additional aspects and/or advantages of the invention will be set forth in part in the description which follows and, in part, will be obvious from the description, or may be learned by practice of the invention.

According to an aspect of the present invention, there is provided an ink level detecting device of an inkjet printer to detect an ink level efficiently and at a low price.

The foregoing and other aspects and/or advantages are realized by providing an ink detecting device of an inkjet printer including: an ink tank including a predetermined amount of ink; a supporting member disposed at a predetermined position to detect when an ink level is decreased below a predetermined level; a luminous member including a self-luminous material and supported by the supporting member; a photo detector to detect a light emitted from the luminous member when the ink level in the ink tank is lower than the predetermined level.

According to an aspect of the present invention, the ink detecting device further includes a transparent window disposed at a corresponding position of the supporting member to pass the light from the luminous member, wherein the photo detector detects the light passed through the transparent window.

The luminous member may be a luminous paper.

The supporting member may be disposed at a sidewall of the ink tank.

The supporting member may be disposed at a bottom of the ink tank.

According to an aspect of the present invention, there is provided an inkjet printer including an ink level detecting device, the inkjet printer including: a photo detector; and an ink level detecting device detecting an amount of residual ink in the printer using the photo detector, and including a luminous member including a self-luminous material or a material with fluorescent or luminous paints to detect when a level of ink is lower than a predetermined level during a printing operation without a separate light source.

According to an aspect of the present invention, there is provided an ink detecting device of an inkjet printer, including: a luminous member including a self-luminous material to detect when a level of ink is lower than a predetermined level during a printing operation.

Additional advantages, aspects, and features of the invention will be set forth in part in the description which follows and in part will become apparent to those having ordinary skill in the art upon examination of the following or may be learned from practice of the invention. The aspects and/or advantages of the invention may be realized and attained as particularly pointed out in the appended claims.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a schematic block diagram showing a part of a printer including an ink level detecting device, according to an aspect of the present invention;

FIG. 2 a view showing the ink level detecting device, in accordance with an aspect of the present invention, when ink is full;

FIG. 3 a view showing the ink level detecting device when the ink is exhausted, in accordance with an aspect of the present invention; and

FIG. 4 a view showing the ink level detecting device, in accordance with another aspect of the present invention.

### DETAILED DESCRIPTION OF THE PREFERRED EMBODIMENTS

Reference will now be made in detail to the present aspects of the present invention, examples of which are illustrated in the accompanying drawings, wherein like reference numerals refer to the like elements throughout. The aspects are described below in order to explain the present invention by referring to the figures.

FIG. 1 is a schematic block diagram showing a part of a printer including an ink level detecting device, according to an aspect of the present invention.

The ink level detecting device 100 (100′) detects an amount of residual ink in an ink tank 10 (10′) of the printer using a photo detector 20 (20′). The ink level detecting device 100 (100′) particularly detects when a level of the ink is lower than a predetermined level, referred to as ink low hereinbelow, during a printing operation.

A controller 30 controls overall operations of the printer and outputs a signal indicative that the ink is low on output devices, such as, a display 40 and/or a speaker (not shown) when the ink level detecting device detects ink is insufficient.

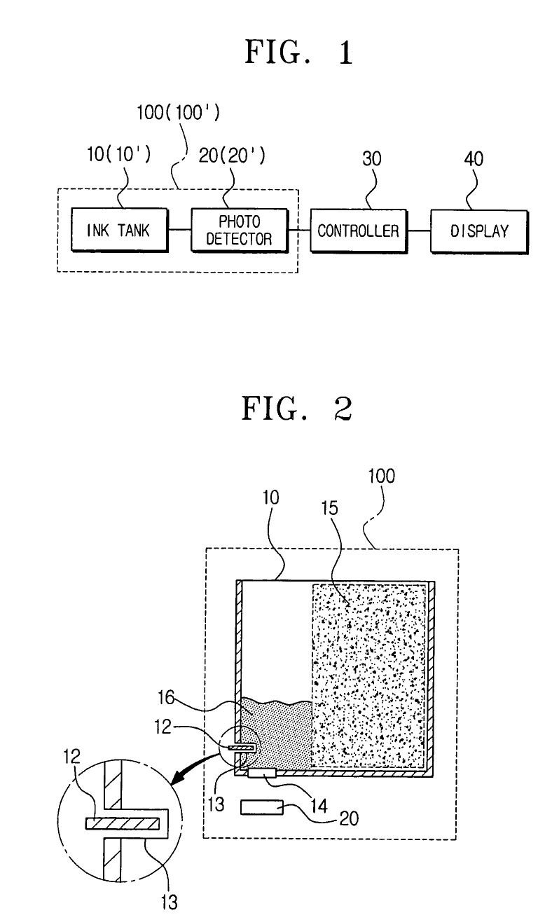

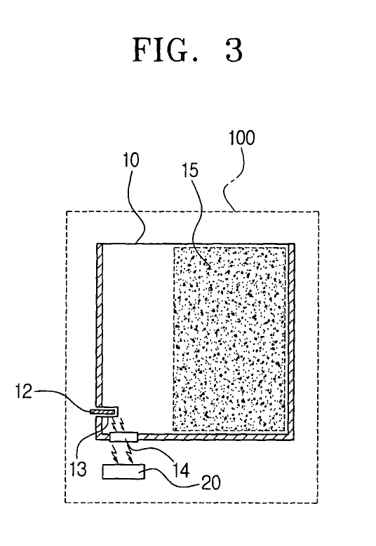

FIGS. 2 and 3 are views showing the ink level detecting device 100 (100′) inkjet printer, in accordance with an aspect of the present invention.

FIG. 2 is a schematic view showing the ink level detecting device when the ink is full.

FIG. 3 is a schematic view showing the ink level detecting device when the ink is exhausted.

Referring to FIGS. 2 and 3, the ink level detecting device includes an ink tank 10, a supporting member 13, a luminous member 12, a transparent window 14 and a photo detector 20.

The ink tank 10 contains a liquid carrier and a toner used as a developer for the inkjet printer.

The ink tank 10 includes a sponge 15 to contain the ink, thus, enabling the printer (not shown) to print a predetermined number of papers even when the level of ink is detected to be lower than the predetermined level.

The supporting member 13 is disposed at a specific position to detect when the ink is low. Here, the supporting member 13 is disposed at a sidewall of the ink tank 10.

The luminous member 12 inserted in the supporting member 13 includes a material capable of emitting lights without a separate light source.

The luminous member 12 may be a self-luminous paper or a member with fluorescent or luminous paints applied thereon, capable of being inserted into the supporting member 13.

The self-luminous paper is used to land strips of airports, in watches, inside of aircrafts, for indicators of directions and exits of buildings and mines, and for map readers. Life spans of various kinds of luminous products using self-luminous line sources are closely related to a primary radiation power and a size of the line sources (visible area).

The life spans of the luminous products, thus, are specified according to options of the products using the luminous producet. And a brightness thereof may reach beyond 5,000L and may further increase by 250% using additional conventional reflecting paint. An indicating lamp for safety may have 10 years of life and an exit indicating lamp may have 10, 15 or 20 years of life.

Fluorescent paint, which includes fluorescent material, continues emitting the light for a certain period of time when the painting thereof is stimulated by the lights, such as, a long wavelength or ultraviolet rays and even after the stimulation is removed. A corresponding vehicle may be vinyl chloride resin, phtalic acid resin, styrol resin or methacylic resin.

Luminous paint, which is one of the fluorescent paints including radiation material, such as radium, emits the light without any stimulation. A corresponding vehicle may be methacylic resin or phtalic acid resin. The luminous paint is used for load signs, clocks, meters, and advertisements.

The transparent window 14 includes a material capable of passing the light from the luminous member 12 and may be disposed at a corresponding position of the supporting member 13. Here, the transparent window 14 is disposed at the bottom of the ink tank 10.

The photo detector 20 is disposed to correspond to the supporting member 13 to detect the light from the luminous member 12. The photo detector 20 may include only a light receiving unit to receive lights.

Hereinafter, the operation of the ink level detecting device 100 will be described.

Referring to FIG. 2, because the ink tank 10 is full with the ink level being over the transparent window 14, the light from the luminous member 12, even if the light is emitted, cannot pass through the transparent window 12. Therefore, the photo detector 20 cannot detect any light.

Referring to FIG. 3, because the ink tank 10 is not full with the ink level being under the transparent window 14, the light emitted from the luminous member 12 can pass through the transparent window 12. The photo detector 20 detects the light through the transparent window 14 to output to the controller 30. Consequently, the controller 30 determines whether the ink is low and outputs a control signal to the display devices, such as, the display 40 and the speaker (not shown) to announce that the ink is low.

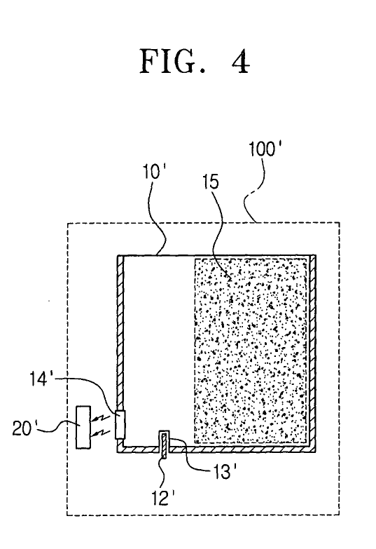

FIG. 4 a view showing the ink level detecting device of the inkjet printer, in accordance with another aspect of the present invention. Referring to FIG. 4, the ink level detecting device comprises a ink tank 10′, a supporting member 13′, a luminous member 12′, a transparent window 14′ and a photo detector 20′. The ink tank 10′ includes a predetermined amount of ink 16 which is used as the developer. The supporting member 13′ is disposed at a bottom of the ink tank 10′.

The luminous member 12′ inserted into the supporting member 13′ includes a material capable of emitting lights without the separate light source. The luminous member 12′ may be the self-luminous paper or a member with the fluorescent or the luminous paints applied thereon, capable of being inserted into the supporting member 13′.

The transparent window 14′ includes a material capable of passing the light from the luminous member 12′ and may be disposed at a corresponding position of the supporting member 13′. Here, for illustrative purposes, the transparent window 14′ is disposed at a sidewall of the ink tank 10′.

The photo detector 20′ is disposed to correspond to the supporting member 13′ to detect the light from the luminous member 12′. The photo detector 20′ may include only the light receiving unit to receive the light. When the ink tank 10′ of the ink level detecting device 100′ is not full with the ink level being under the transparent window 14′, the light emitted from the luminous member 12′ can pass through the transparent window 12′. The photo detector 20′ detects the light through the transparent window 14′ to output to the controller 30′.

Consequently, the controller 30′ determines whether the ink is low and outputs a control signal to the display devices, such as, the display 40 or the speaker (not shown) to announce that the ink is low.

According to an aspect of the present invention, the luminous paper is disposed at a predetermined position of an ink tank to detect whether the ink is low in the ink tank by detecting a light emitted therefrom, thereby capable of detecting that the ink is low in an inkjet printer efficiently and at low price.

Although a few aspects of the present invention have been shown and described, it would be appreciated by those skilled in the art that changes may be made in this aspect without departing from the principles and spirit of the invention, the scope of which is defined in the claims and their equivalents.

What is claimed is:

1. An ink detecting device of an inkjet printer, comprising:
an ink tank comprising a predetermined amount of ink;
a supporting member disposed at a predetermined position to detect when an ink level is decreased below a predetermined level;
a luminous member comprising a self-luminous material and supported by the supporting member; and
a photo detector to detect a light emitted from the luminous member when the ink level in the ink tank is lower than the predetermined level.

2. The ink detecting device according to claim 1, further comprising:
a transparent window disposed at a corresponding position of the supporting member to pass the light from the luminous member,
wherein the photo detector detects the light passed through the transparent window.

3. The ink detecting device according to claim 1, wherein the luminous member is a luminous paper.

4. The ink detecting device according to claim 1, wherein the luminous member is a luminous paint.

5. The ink detecting device according to claim 1, wherein the supporting member is disposed at a sidewall of the ink tank.

6. The ink detecting device according to claim 1, wherein the supporting member is disposed at a bottom of the ink tank.

7. An inkjet printer comprising an ink level detecting device, the inkjet printer comprising:
a photo detector; and
an ink level detecting device detecting an amount of residual ink in the printer using the photo detector, and comprising a luminous member comprising a self-luminous material or a material with fluorescent or luminous paints to detect when a level of ink is lower than a predetermined level during a printing operation without a separate light source.

8. The ink detecting device according to claim 7, further comprising:
a controller controlling operations of the inkjet printer and outputting a signal indicative that the level of ink is lower than the predetermined level to an output device.

9. The ink detecting device according to claim 7, wherein the output device comprises a display.

10. The ink detecting device according to claim 7, wherein the ink level detecting device comprises
an ink tank comprising a liquid carrier and a toner used as a developer for the inkjet printer,
a supporting member disposed at a sidewall of the ink tank to detect when the ink is low,
a transparent window passing a light from the luminous member and disposed at a bottom of the ink tank, and
a photo detector detecting the light from the luminous member.

11. The ink detecting device according to claim 10, wherein when the ink tank is full, the ink level is over the transparent window and the light from the luminous member cannot pass through the transparent window, and the photo detector cannot detect any light.

12. The ink detecting device according to claim 10, wherein when the ink tank is not full, the ink level is under the transparent window and the light emitted from the luminous member passes through the transparent window.

13. The ink detecting device according to claim 7, wherein the ink level detecting device comprises
an ink tank comprising a liquid carrier and a toner used as a developer for the inkjet printer,
a supporting member disposed at the bottom of the ink tank to detect when the ink is low,
a transparent window passing a light from the luminous member and disposed at a sidewall of the ink tank, and
a photo detector detecting the light from the luminous member.

14. An ink detecting device of an inkjet printer, comprising:
a luminous member comprising a self-luminous material to detect when a level of ink is lower than a predetermined level during a printing operation.

15. The ink detecting device according to claim 14, wherein the luminous paper is disposed at a predetermined position of an ink tank to detect whether the ink is lower than the predetermined level using a light emitted therefrom.
